(19) United States
(12) Patent Application Publication
(10) Pub. No.: US 2026/0214182 A1
(43) Pub. Date: Jul. 23, 2026

(54) SYSTEM AND METHOD FOR PROJECTION IMAGE FUSION CORRECTION AND NON-TRANSITORY COMPUTER READABLE STORAGE MEDIUM

(71) Applicant: Coretronic Projection (Kunshan) Corporation, Jiangsu (CN)

(72) Inventor: JIAHENG GUO, Jiangsu (CN)

(73) Assignee: Coretronic Projection (Kunshan) Corporation, Jiangsu (CN)

(21) Appl. No.: 19/430,224

(22) Filed: Dec. 22, 2025

(30) Foreign Application Priority Data
Jan. 17, 2025 (CN) 202510075464.7

(51) Int. Cl. H04N 5/74; G03B 21/14; G06T 5/50; G06T 7/70

(52) U.S. Cl. CPC H04N 5/74; G03B 21/142; G06T 5/50; G06T 7/70; G06T 2207/20221

(57) ABSTRACT

A system and a method for projection image fusion correction and a non-transitory computer readable storage medium are provided. The method includes: after the electronic device is communicatively connected to multiple projectors, controlling each of the projectors to project to form multiple correction images on a projection surface; generating a captured image including an imaging region corresponding to the correction images through an image capturing device; transmitting fusion information including the captured image to an artificial intelligence calculation module for identification analysis processing to generate adjustment information; generating an adjustment command according to the adjustment information and projector information; and transmitting the adjustment command to the corresponding projector to adjust a projection parameter.

### CROSS-REFERENCE TO RELATED APPLICATION

This application claims the priority benefit of China application serial no. 202510075464.7, filed on January 17, 2025. The entirety of the above-mentioned patent application is hereby incorporated by reference herein and made a part of this specification.

### BACKGROUND

### Technical Field

The disclosure relates to a multi-projector splicing technology, and more particularly to a method for projection image fusion correction and a system for projection image fusion correction.

### Description of Related Art

Multi-projector splicing technology splices images projected by multiple projectors into one large image to improve the overall resolution and the visual impact and is widely applied to fields such as exhibitions, advertising, and virtual reality. However, during the splicing (fusion) process of the images projected by the projectors, issues such as image misalignment, color difference, and uneven brightness often occur, affecting the overall visual effect.

In the prior art, there are mainly two types of correction of fusion images of multiple projectors, that is, a software fusion correction solution and a hardware fusion correction solution. The software fusion correction solution captures images projected by multiple projectors onto a projection surface such as a screen or a wall through cameras built in the projectors or cameras externally connected to the projectors, transmits the captured images to a host computer through a local area network, analyzes and calculates the captured images via a professional image algorithm software installed on the host computer to derive parameters to be adjusted for each projector, and then sends the adjustment parameters to each projector through the local area network for adjustment to achieve image fusion. The hardware fusion correction solution captures specific fusion correction images containing calibration points projected by multiple projectors before fusion correction through dedicated hardware equipment for fusion projection correction, such as using cameras, analyzes and calculates parameters to be adjusted for each projector via an image algorithm module in the hardware equipment, and then sends the adjustment parameters to each projector for adjustment.

Most of the conventional methods for multi-projector fusion image correction rely on hardware correction components of the projectors or manual calibration, which has issues such as high cost, complex operation, and great limitations. In addition, the conventional methods are difficult to ensure good projection effects when faced with complex geometric shapes or dynamically changing light and shadow environments.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

Other objectives, features and advantages of the disclosure will be further understood from the further technological features disclosed by the embodiments of the disclosure wherein there are shown and described preferred embodiments of this invention, simply by way of illustration of modes best suited to carry out the invention.

A method for projection image fusion correction of the disclosure is adapted to a system for projection image fusion correction. The system for projection image fusion correction includes multiple projectors, an artificial intelligence calculation module, and an electronic device. The electronic device includes a communication connector, an image capturing device, and a processor. The processor is coupled to the communication connector and the image capturing device and is configured to execute the method for projection image fusion correction. The method including the following steps. Each of the multiple projectors is communicatively connected to the communication connector. Each of the multiple projectors is controlled to project multiple correction images on a projection surface. The multiple correction images have at least one overlapping region on the projection surface. The image capturing device is enabled, so that the image capturing device generates a captured image in response to image capture. The captured image includes an imaging region corresponding to the multiple correction images. The captured image from the image capturing device is obtained, and fusion information including the captured image is transmitted to the artificial intelligence calculation module. The artificial intelligence calculation module performs identification analysis processing on the imaging region of the captured image, and generates at least one adjustment information. The at least one adjustment information corresponds to at least one projector among the multiple projectors. At least one adjustment command is generated according to the at least one adjustment information and multiple projector information of the multiple projectors. The multiple projector information respectively correspond to the multiple projectors, and the at least one adjustment command corresponds to the at least one projector of the multiple projectors. The at least one adjustment command is transmitted to the at least one projector of the corresponding multiple projectors by the communication connector. The at least one projector of the multiple projectors adjusts a projection parameter based on the correspondingly received at least one adjustment command.

A system for projection image fusion correction of the disclosure includes multiple projectors, an artificial intelligence calculation module, and an electronic device. The electronic device includes a communication connector, an image capturing device, and a processor. The communication connector is configured to be communicatively connected to each of the multiple projectors. The processor is coupled to the communication connector and the image capturing device and is configured to execute the method for projection image fusion correction.

A non-transitory computer readable storage medium of the disclosure stores an application program executable by a processor and is configured to complete the method for projection image fusion correction when the application program is executed by the processor.

### BRIEF DESCRIPTION OF THE DRAWINGS

FIG. 1 is a block diagram of a system for projection image fusion correction according to an embodiment of the disclosure.

FIG. 2 is a flowchart of a method for projection image fusion correction according to an embodiment of the disclosure.

FIG. 3 is a schematic diagram of multiple correction images projected onto a projection surface according to an embodiment of the disclosure.

FIG. 4 is a schematic diagram of a correction image projected onto a projection surface by a projector according to an embodiment of the disclosure.

FIG. 5 is a flowchart of an APP operation according to an embodiment of the disclosure.

FIG. 6A to FIG. 6C are schematic diagrams of activating an APP according to an embodiment of the disclosure.

FIG. 7A and FIG. 7B are schematic diagrams of a guide page for selecting a Wi-Fi connection according to an embodiment of the disclosure.

FIG. 8A and FIG. 8B are schematic diagrams of a guide page for selecting a Bluetooth connection according to an embodiment of the disclosure.

FIG. 9 is a schematic diagram of a guide page for selecting a fusion ratio according to an embodiment of the disclosure.

FIG. 10 is a schematic diagram of a guide page for capturing a correction image according to an embodiment of the disclosure.

FIG. 11 is a schematic diagram of analyzing a captured image according to an embodiment of the disclosure.

FIG. 12 is a schematic diagram of analyzing a fusion image according to an embodiment of the disclosure.

FIG. 13 is a schematic diagram of AI computation and sending an analysis result to an electronic device according to an embodiment of the disclosure.

FIG. 14 is a schematic diagram of a guide page after fusion correction is completed according to an embodiment of the disclosure.

FIG. 15 is a schematic diagram of a guide page for manual fusion correction according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

The disclosure provides a method for projection image fusion correction, a system for projection image fusion correction, and a non-transitory computer readable storage medium, which can implement seamless fusion projection of multiple projectors.

Other purposes and advantages of the disclosure may be further understood from the technical features disclosed by the invention.

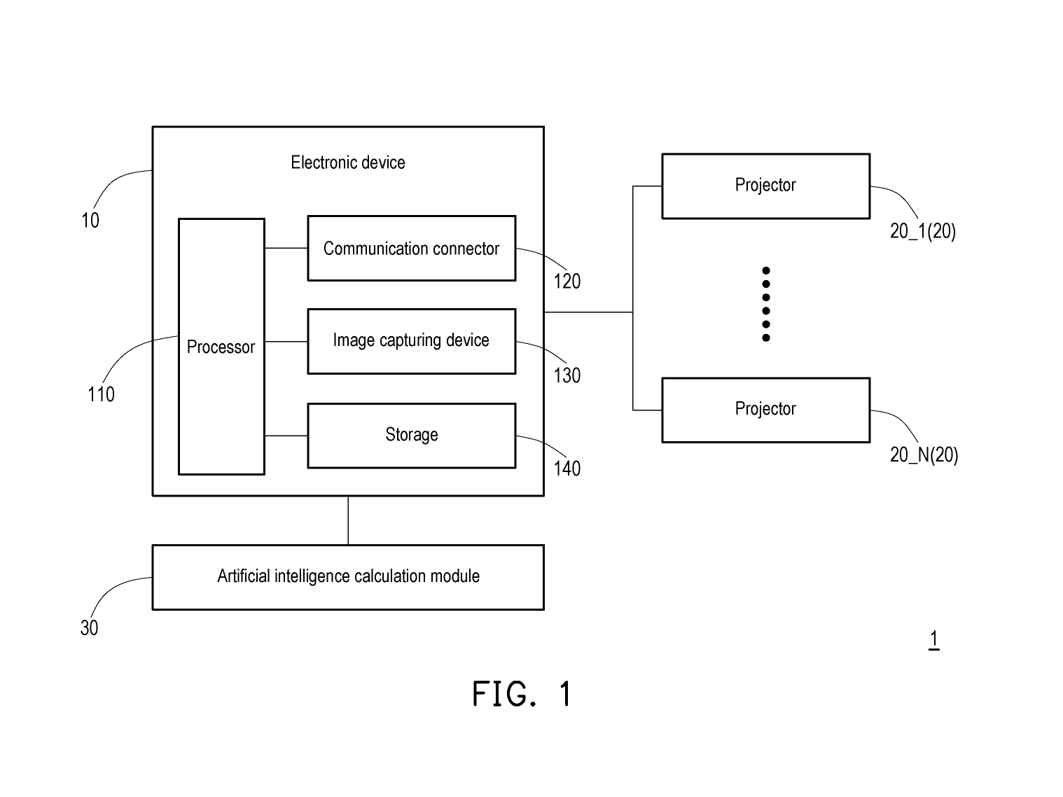

FIG. 1 is a block diagram of a system for projection image fusion correction according to an embodiment of the disclosure. Please refer to FIG. 1. A system for projection image fusion correction 1 includes an electronic device 10, multiple projectors 20_1 to 20_N (collectively referred to as projectors 20), and an artificial intelligence calculation module 30. The electronic device 10 includes a processor 110, a communication connector 120, an image capturing device 130, and a storage 140. The processor 110 is coupled to the communication connector 120, the image capturing device 130, and the storage 140. The number of the processor 110 may be one or more, and only one processor 110 is shown here for the convenience of description. The coupling is, for example, a connection of electrical signals.

The processor 110 may be a central processing unit (CPU), a physical processing unit (PPU), a programmable microprocessor, an embedded control chip, a digital signal processor (DSP), an application specific integrated circuit (ASIC), a field programmable gate array (FPGA), a digital data processor (DDP), a digital controller, or other similar devices.

The communication connector 120 transmits and receives signals wirelessly or by wire. For example, the communication connector 120 is a wired communication interface and/or a wireless communication interface. The wired communication interface may be implemented by a universal serial bus (USB) port, a general purpose interface bus (GPIB) port, or a local area network (LAN) port. The wireless communication interface may be implemented by a wireless local area network (WLAN) interface, a cellular network communication interface, or a combination thereof. Alternatively, the communication connector 120 may be a wired/wireless signal transceiving device such as a Bluetooth signal transceiver. Alternatively, the communication connector 120 may also be a hardware component integrating a Wi-Fi module and a Bluetooth module.

The image capturing device 130 is, for example, a video camera, a camera, etc. adopting a charge coupled device (CCD) lens or a complementary metal oxide semiconductor transistor (CMOS) lens. The image capturing device 130 may be built in the electronic device 10 or the image capturing device 130 may be another independent device different from the electronic device 10 and configured to be externally connected to the electronic device 10, but not limited thereto.

The storage 140 is, for example, any type of fixed or removable random access memory (RAM), read-only memory (ROM), flash memory, hard disk drive (HDD), solid state drive (SSD), similar elements, or a combination of the above elements and is configured to store various modules or various application programs executable by the processor 110.

The projectors 20 are configured to project image beams to form projection images on a projection surface such as a curtain, a tabletop, or a wall. The projector 20 includes components such as an imaging element (for example, a light valve), a projection lens, a light source, an optical element for transmitting a light beam (for example, a mirror, a light splitting element, and a lens element, etc.), wherein the light source includes, for example, a light emitting diode (LED), a laser diode (LD), or a combination thereof. The imaging element is, for example, a reflective optical modulator such as a liquid crystal on silicon panel (LCoS panel) or a digital micro-mirror device (DMD). In some embodiments, the imaging element may also be a transparent liquid crystal panel, an electro-optical modulator, a magneto-optical modulator, an acousto-optical modulator (AOM), or other transmissive optical modulators.

The artificial intelligence (AI) calculation module 30 may be disposed in the electronic device 10 or in a cloud server. The artificial intelligence calculation module 30 may be implemented by adopting a large language model that may support image recognition, such as chat generative pre-trained transformer (ChatGPT), Google Gemini, or Claude, but only as an example and not limited thereto.

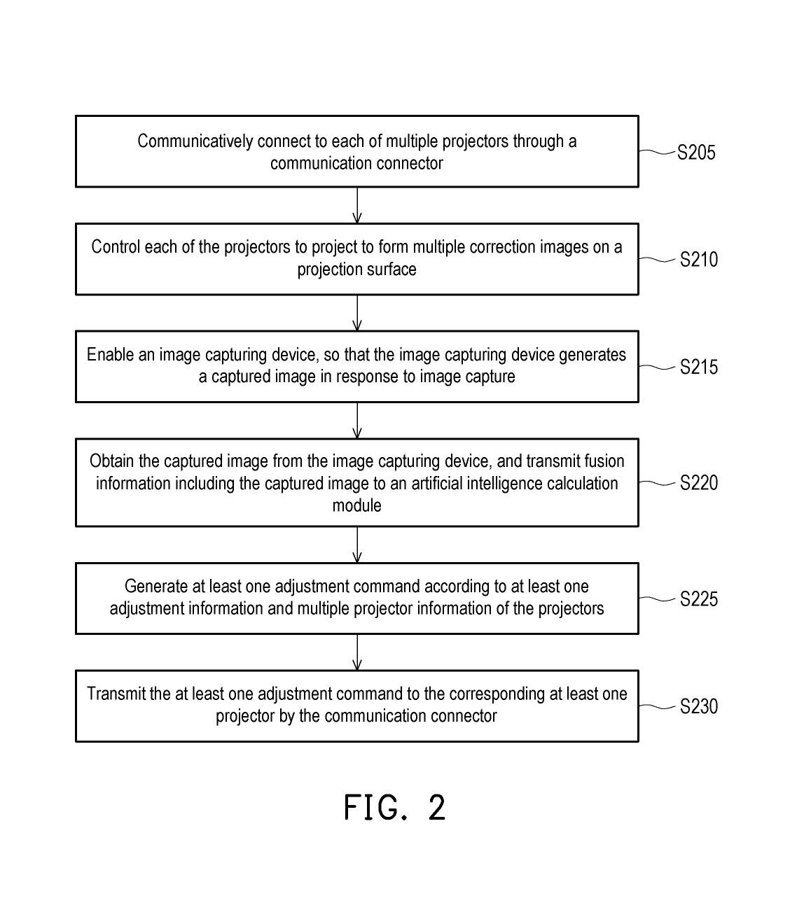

FIG. 2 is a flowchart of a method for projection image fusion correction according to an embodiment of the disclosure. Please refer to FIG. 2. In step S205, each of the projectors 20 (that is, the projectors 20_1 to 20_N) is communicatively connected to the communication connector 120 of the electronic device 10. In the embodiment, the electronic device 10 and the projectors 20 for image splicing are located in the same local area network, or the electronic device 10 and the projectors 20 for image splicing are paired via Bluetooth to be in the same personal area network, but only as an example and not limited thereto.

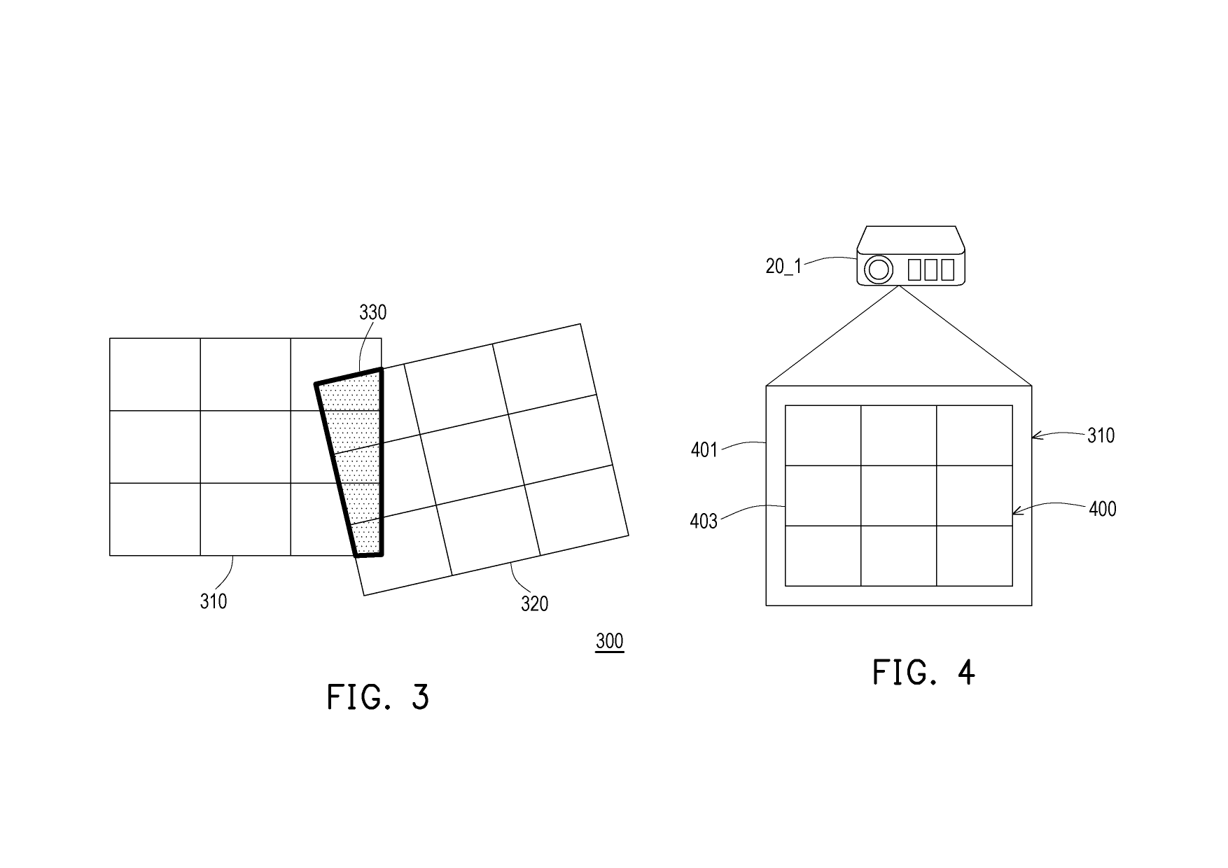

Next, in step S210, each of the projectors 20_1 to 20_N is controlled to project to form multiple correction images on the projection surface, and the multiple correction images have at least one overlapping region on the projection surface. The multiple projectors 20 all adopt the same resolution for projection. For example, FIG. 3 is a schematic diagram of multiple correction images projected onto a projection surface according to an embodiment of the disclosure. Please refer to FIG. 3. In the embodiment, it is assumed that two projectors 20_1 and 20_2 are configured. The projectors 20_1 and 20_2 are placed adjacent to each other when being installed. Therefore, when step S210 is executed and the projectors 20_1 and 20_2 respectively project, a correction image 310 and a correction image 320 are respectively formed on a projection surface 300, and the correction image 310 and the correction image 320 have an overlapping region 330 on the projection surface 300.

FIG. 4 is a schematic diagram of a correction image projected onto a projection surface by a projector according to an embodiment of the disclosure. In the embodiment, the correction image 310 formed on the projection surface 300 by the projector 20_1 is used for illustration. Please refer to FIG. 4. Image data corresponding to the correction image 310 may be pre-stored in the storage of the projector 20_1, so that the projector 20_1 may project the image data in response to the control of the processor 100 of the electronic device 10 to form the correction image 310 on the projection surface 300. The correction image 310 has a correction pattern 400. There is a spacing between a pattern boundary 403 of the correction pattern 400 and a projection boundary 401 of the corresponding correction image 310. The spacing is configured to provide a space for displacement adjustment during projection image fusion correction. In an embodiment, a wireframe with a white background and a black frame (for example, a 3×3 wireframe) is used as the correction pattern 400. In other embodiments, other regularly arranged patterns, an irregularly arranged pattern, or a polygon with a specific shape may also be adopted as the correction pattern, but not limited thereto. In an embodiment, the projectors 20_2 to 20_N also adopt the same image data as the correction image 310 for projection to generate the multiple correction images, and the projectors 20_1 to 20_N all adopt the same resolution for projection.

Please refer to FIG. 2. Then, in step S215, the image capturing device 130 of the electronic device 10 is enabled, so that the image capturing device 130 generates a captured image in response to image capture, and the captured image includes an imaging region corresponding to the correction images. Specifically, in step S215, a user may operate the electronic device 10 to capture an image toward the projection surface 300, so that the image capturing device 130 generates the captured image including the imaging region.

In an embodiment, during image capture, if the electronic device 10 (for example, a smart phone) is kept parallel to the projection surface 300 as much as possible, a subsequent fusion correction calculation may achieve a good result. Therefore, in order to ensure that the generated captured image is not tilted in the vertical and horizontal directions, a tilt angle of the electronic device 10 may be obtained by using an inertial sensor such as a gyroscope to perform a compensation calculation in advance. That is, in step S215, the posture of the electronic device 10 relative to the direction of gravity during image capture may be further detected through the inertial sensor (not shown) built in the electronic device 10 to obtain posture information. The electronic device 10 performs compensation correction on the captured image according to the posture information, and in subsequent step S220, the captured image after compensation correction is transmitted to the artificial intelligence calculation module 30 as a part of fusion information.

Specifically, in step S220, the processor 110 of the electronic device 10 obtains the captured image (or the captured image after compensation correction) from the image capturing device 130, and transmits the fusion information including the captured image (or the captured image after compensation correction) to the artificial intelligence calculation module 30. After receiving the fusion information, the artificial intelligence calculation module 30 performs identification analysis processing on the imaging region in the captured image to sequentially generate corresponding adjustment information for the multiple projectors 20 that need to be adjusted. For example, the imaging region of the captured image corresponds to the multiple correction images 310 and 320 shown in FIG. 3. When the artificial intelligence calculation module 30 performs the identification analysis processing on the imaging region, a part corresponding to the overlapping region 330 is first identified, a region corresponding to one of the correction images 310 and 320 is used as a reference, and according to the part corresponding to the overlapping region 330, information such as the angle and the displacement that need to be adjusted for a region corresponding to the other one of the correction images 310 and 320 is calculated to generate the adjustment information to eliminate the part corresponding to the overlapping region 330. One adjustment information corresponds to one projector 20. In other embodiments, if the imaging region includes multiple parts corresponding to the overlapping region 330, multiple adjustment information corresponding to the multiple projectors 20 may be sequentially calculated with the above manner of eliminating the part corresponding to the overlapping region 330.

In an embodiment, the fusion information further includes arrangement information of the multiple projectors 20. In detail, the processor 110 of the electronic device 10 generates the arrangement information according to the arrangement manner of the multiple projectors 20. A method for the processor 110 to obtain the arrangement manner of the multiple projectors 20 is, for example, in response to the electronic device 10 being respectively communicatively connected to each of the projectors 20_1 to 20_N among the multiple projectors 20, the processor 110 prompts multiple arrangement manners, such as a horizontal arrangement, a vertical arrangement, or an array arrangement, of the projectors 20 for the user to select one of the arrangement manners, and configure the multiple projectors 20 accordingly. In this way, the processor 110 may generate the arrangement information according to the arrangement manner selected by the user to be used by the artificial intelligence calculation module 30 during the identification analysis processing. In an embodiment, the arrangement information generated by the processor 110 includes a projector number corresponding to each of the projectors 20_1 to 20_N among the multiple projectors 20. The artificial intelligence calculation module 30 may identify the multiple projectors 20 according to the projector number in the information. Meanwhile, the adjustment information may further include the corresponding projector number.

In an embodiment, the fusion information further includes fusion ratio information. Specifically, in response to the electronic device 10 being respectively communicatively connected to the multiple projectors 20, the processor 110 prompts multiple fusion ratios of the projection images of the multiple projectors 20 for the user to select. For example, the multiple fusion ratio (for example, the aspect ratio of the fused image) includes 32:9, 28:9, 26:9, 24:9, etc. In response to selecting one of the multiple fusion ratios, the processor 110 generates the fusion ratio information.

In an embodiment, the identification analysis processing of the artificial intelligence calculation module 30 includes an image processing algorithm. The artificial intelligence calculation module 30 may automatically identify the edge, the overlapping region, and the color difference of the correction pattern corresponding to each correction image for the imaging region included in the captured image, calculate an appropriate fusion strategy through the complex image processing algorithm, and transmit the adjustment information to the electronic device 10.

Afterwards, in step S225, the processor 110 of the electronic device 10 generates at least one adjustment command according to the at least one adjustment information generated by the artificial intelligence calculation module 30 and the multiple projector information of the multiple projectors 20. The multiple projector information respectively correspond to the multiple projectors 20, and the at least one adjustment command corresponds to the at least one projector among the multiple projectors 20. As described above, since the adjustment information also includes the corresponding projector number, the processor 110 may generate the adjustment command of the corresponding projector 20 according to the projector number in the adjustment information. In short, the processor 110 obtains the adjustment command executable by the projector 20 according to the adjustment information and the projector information.

In an embodiment, the projector information is obtained such that, for example, in response to the electronic device 10 being communicatively connected to each of the projectors 20_1 to 20_N, the processor 110 further obtains the corresponding projector information from each of the projectors 20_1 to 20_N. The projector information includes the model of the corresponding projector 20 and a command set used.

In an embodiment, the artificial intelligence calculation module 30 generates multiple adjustment information after performing the identification analysis processing, and the multiple adjustment information respectively correspond to the multiple projectors 20. The electronic device 10 generates multiple adjustment commands according to the multiple adjustment information and the multiple projector information, wherein the multiple adjustment commands respectively correspond to the multiple projectors 20. After generating the multiple adjustment commands, the processor 110 determines whether each of the multiple adjustment commands exceeds a threshold of the corresponding projector 20. The threshold refers to adjustable upper and lower limits of the corresponding projector 20. In the case where any of the adjustment commands exceeds the corresponding threshold, the processor 110 regenerates a new adjustment command according to the threshold until each of the adjustment commands does not exceed the corresponding threshold.

In step S230, the processor 110 transmits the at least one adjustment command to the at least one projector among the corresponding projectors 20 by the communication connector 120. The at least one projector 20 receiving the adjustment command adjusts a projection parameter based on the correspondingly received adjustment command. The adjustment includes displacement, rotation, scaling, cropping, brightness adjustment, color balance, etc. Based on this, seamless fusion projection of the multiple projectors may be implemented.

In an embodiment, the method for projection image fusion correction may be implemented by a non-transitory computer readable storage medium. Specifically, the non-transitory computer readable storage medium stores an application (APP) executable by the processor 110. When the APP is executed by the processor 110, the method for projection image fusion correction may be completed.

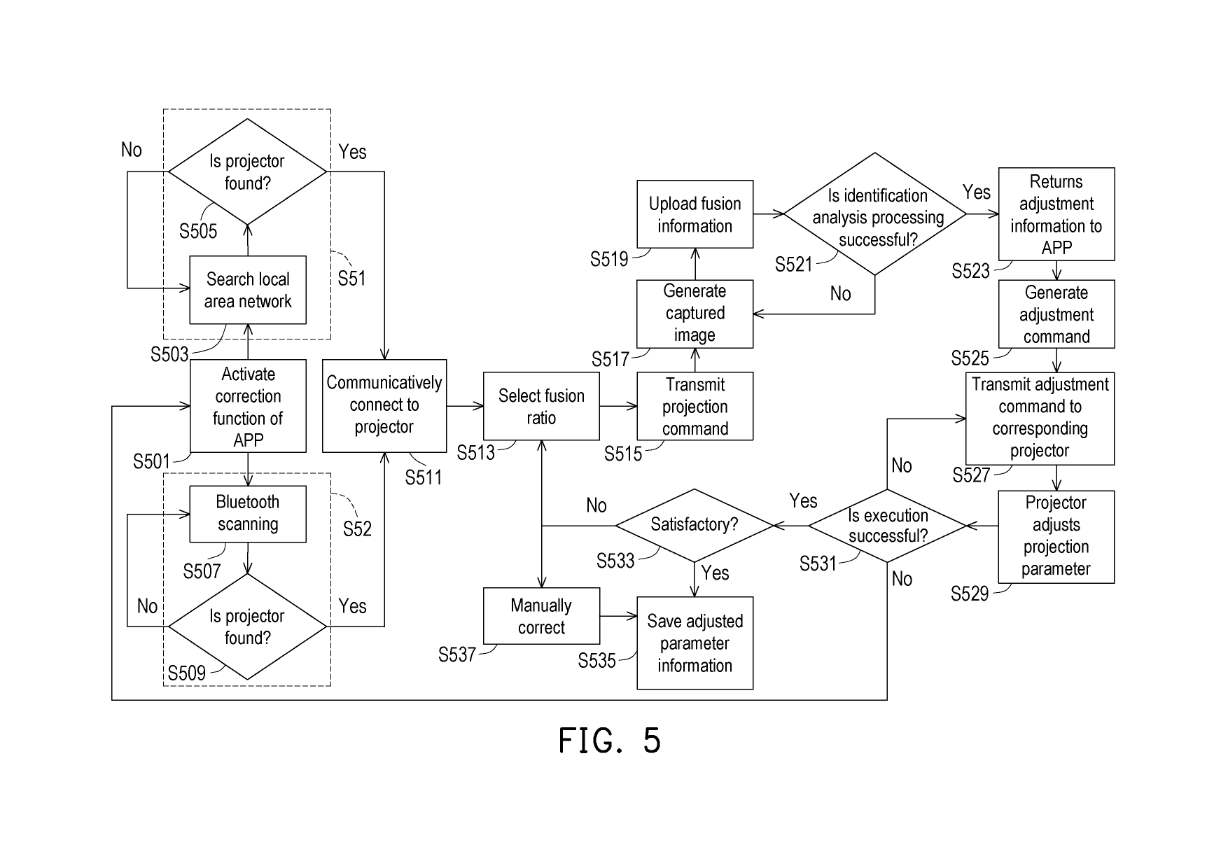

FIG. 5 is a flowchart of an APP operation according to an embodiment of the disclosure. Please refer to FIG. 5. In step S501, a correction function is activated through the APP to start steps of projection image fusion correction of the multiple projectors 20. When used for the first time, the user needs to use the electronic device 10 (for example, a smart phone) with a computing function and a networking function to download and install the APP for fusion correction on a corresponding APP distribution platform, and then execute the APP and execute a fusion correction function according to guidance. The APP is a mobile application program developed specifically for projection image fusion correction. The main architecture is similar to a traditional internet of things application, the APP plays the role of an intermediate communication medium, and the functions are equivalent to the combination of software and hardware in a traditional fusion correction solution. The principle is to call some hardware functions of the smart phone through a program, such as calling the network and the Bluetooth module for a communication function.

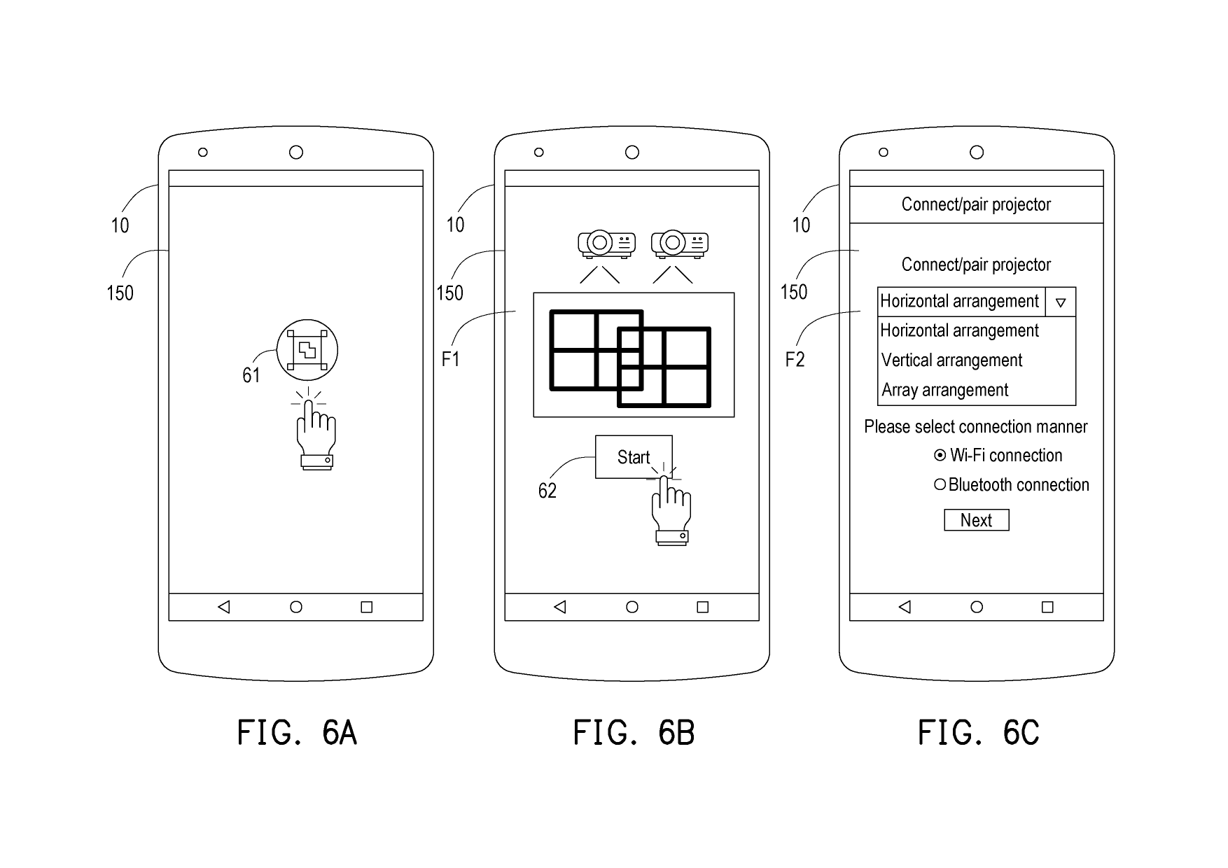

The following description uses a smart phone as the electronic device 10 as an example. FIG. 6A to FIG. 6C are schematic diagrams of activating an APP according to an embodiment of the disclosure. Please refer to FIG. 6A. After the user installs the APP for fusion correction on the electronic device 10, an icon 61 corresponding to the APP is displayed on an output device 150 (for example, a display) of the electronic device 10. After the user triggers the icon 61 (for example, through a touch operation), as shown in FIG. 6B, the output device 150 displays a guide page F1 in a user interface provided by the APP. At this time, the user may issue a fusion correction command by triggering a function option 62 corresponding to “start” in the guide page F1 to activate the correction function (see step S501 in FIG. 5).

After the processor 110 of the electronic device 10 activates the correction function according to the fusion correction command issued by the user, the multiple projectors 20 is communicatively connected. For example, via the guidance of the APP, the multiple projectors 20 and the electronic device 10 may be connected to the same local area network or the multiple projectors 20 and the electronic device 10 may be connected through Bluetooth pairing. In an embodiment, the APP may guide the user to select a connection manner through a prompt of the output device 150. For example, the connection manner includes a Wi-Fi connection (step S51) and a Bluetooth connection (step S52). In addition, the user interface of the APP may further guide the user to select the arrangement manner of the multiple projectors 20. That is, when the electronic device 10 is communicatively connected to the multiple projectors 20, the APP further prompts the user to place the multiple projectors 20 in a specific sequence and at suitable intervals according to the arrangement manner selected by the user.

Please refer to FIG. 6C. After the function option 62 is enabled by triggering, the user interface switches to a guide page F2 as shown in FIG. 6C. In the guide page F2, the user may select the arrangement manner and the connection manner of the multiple projectors 20. The arrangement manner includes the horizontal arrangement (arranged horizontally in a row), the vertical arrangement (arranged vertically in a column), and the array arrangement (including the horizontal arrangement and the vertical arrangement). For example, in terms of the horizontal arrangement, the first projector 20_1 that is successfully communicatively connected is defined as the projector 20 placed on the leftmost side, and the subsequent projectors 20_2 to 20_N that are successfully communicatively connected are sequentially placed to the right. In terms of the vertical arrangement, the placement sequence of the projectors 20 from top to bottom is defined according to the sequence of communicative connections. In terms of the array arrangement, the multiple projectors 20 are sequentially placed in order from left to right and from top to bottom according to the sequence of communicative connections, so as to assign a corresponding number (for example, the projector number) to each of the projectors 20_1 to 20_N among the multiple projectors 20. In an embodiment, when the communicative connection is successful, the processor 110 of the electronic device 10 obtains the multiple projector information (the models, the command sets used, etc., but not limited thereto) of the connected projectors 20.

Please refer to FIG. 5. During the communicative connection, if the Wi-Fi connection is selected (step S51), step S503 is first executed. The processor 110 of the electronic device 10 searches for a local area network through the communication connector 120. Next, in step S505, it is determined whether the projector 20 is found in the local area network. If the projector 20 is found in the local area network, step S511 is executed, in which the projector 20 is communicatively connected. If the projector 20 is not found in the local area network, the process returns to step S503 to search a local area network again.

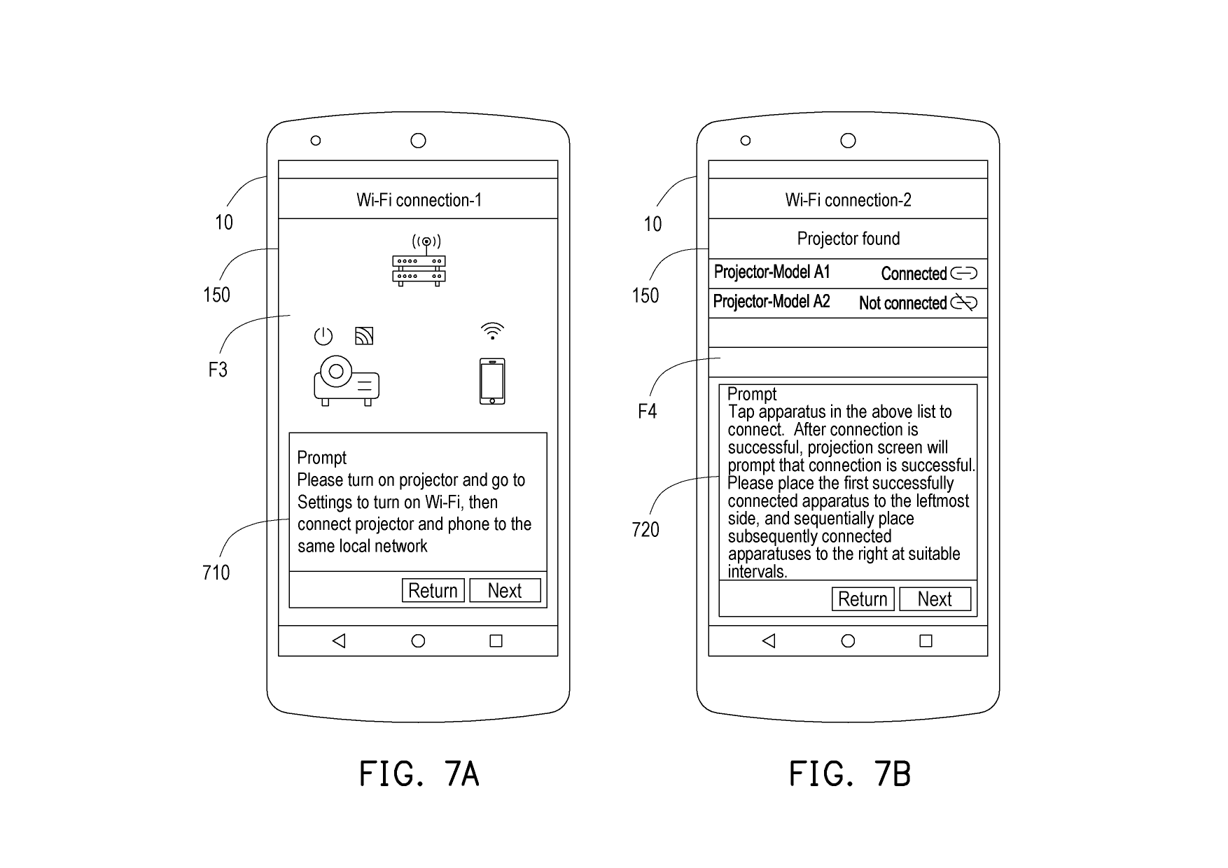

FIG. 7A and FIG. 7B are schematic diagrams of a guide page for selecting a Wi-Fi connection according to an embodiment of the disclosure. In response to the user selecting the Wi-Fi connection in the guide page F2 and tapping the “Next” option, the user interface of the APP switches to a guide page F3 as shown in FIG. 7A, and displays a prompt message 710 in the guide page F3 to guide the user to set the Wi-Fi connection of the projector 20. After the user completes the setting of the Wi-Fi connection of the projector 20 according to the prompt message 710, the user taps the “Next” option in the guide page F3, so that the APP executes step S51. At this time, the user interface of the APP switches to a guide page F4 as shown in FIG. 7B, and displays the found projector 20 in the guide page F4, while displaying a prompt message 720 to guide the user to place the projector 20, so that the arrangement manner of the multiple projectors 20 conforms to the arrangement manner selected in the guide page F2.

Please refer to FIG. 5. On the other hand, during the communicative connection, if the Bluetooth connection is selected (step S52), step S507 is first executed. The processor 110 of the electronic device 10 scans the projector 20 with the Bluetooth module within a range through the communication connector 120. Next, in step S509, it is determined whether the projector 20 is found within the Bluetooth scanning range. If the projector 20 is found, step S511 is executed. The projector 20 is communicatively connected. If the projector 20 is not found within the Bluetooth scanning range, the process returns to step S507 to execute Bluetooth scanning again.

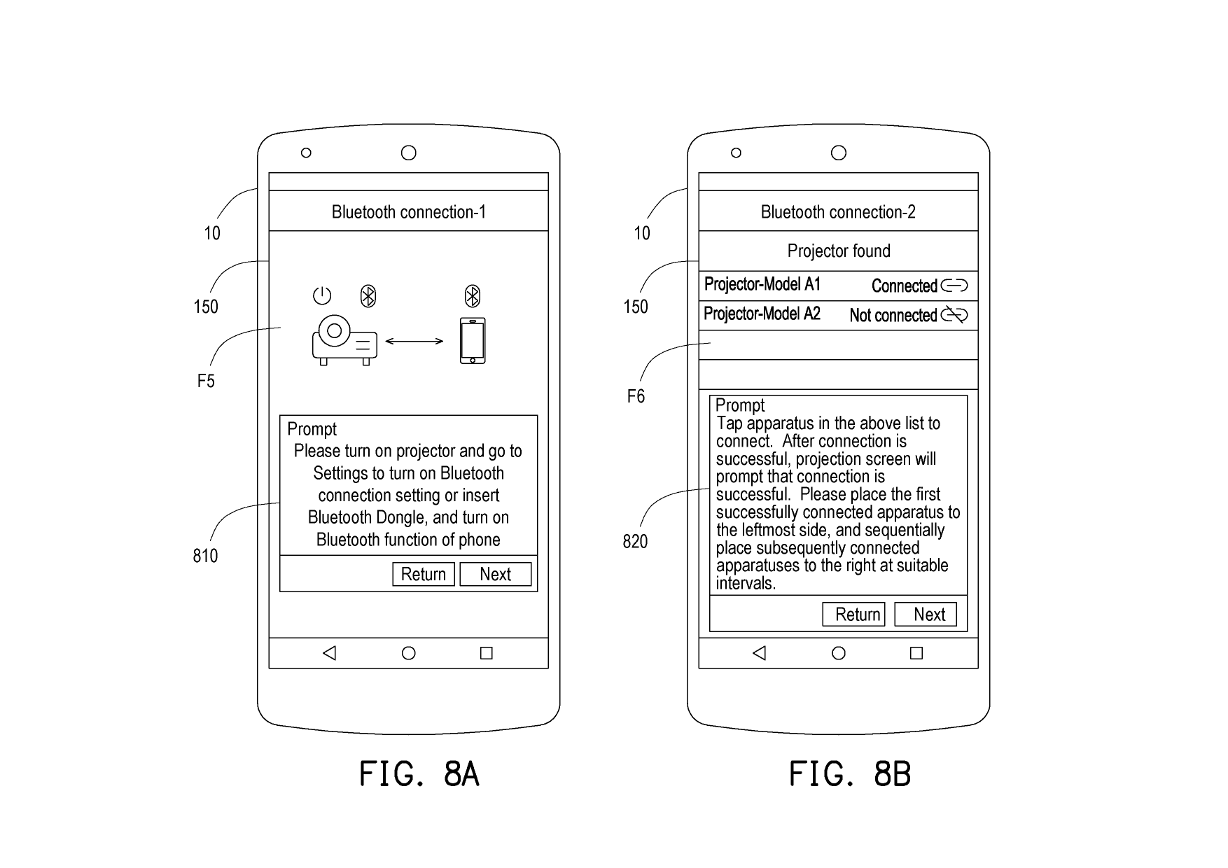

FIG. 8A and FIG. 8B are schematic diagrams of a guide page for selecting a Bluetooth connection according to an embodiment of the disclosure. In response to the user selecting the Bluetooth connection and tapping “Next” in the guide page F2, the user interface of the APP switches to a guide page F5 as shown in FIG. 8A. A prompt message 810 is displayed in the guide page F5 to guide the user to set the Bluetooth connection of the projector 20. After the user completes the setting of the Bluetooth connection of the projector 20 according to the prompt message 810, the user taps the “Next” option in the guide page F5, so that the APP executes step S52. At this time, the user interface of the APP switches to a guide page F6 as shown in FIG. 8B, and displays the found projector 20 in the guide page F6, while displaying a prompt message 820 to guide the user to place the projector 20, so that the arrangement manner of the projectors 20 conforms to the arrangement manner selected in the guide page F2. Taking the horizontal arrangement as an example, the user may place the first successfully connected projector 20 on the leftmost side according to the prompt message (for example, the prompt message 720, 820) provided by the APP, and the subsequent successfully connected projectors 20 are sequentially placed to the right at suitable intervals.

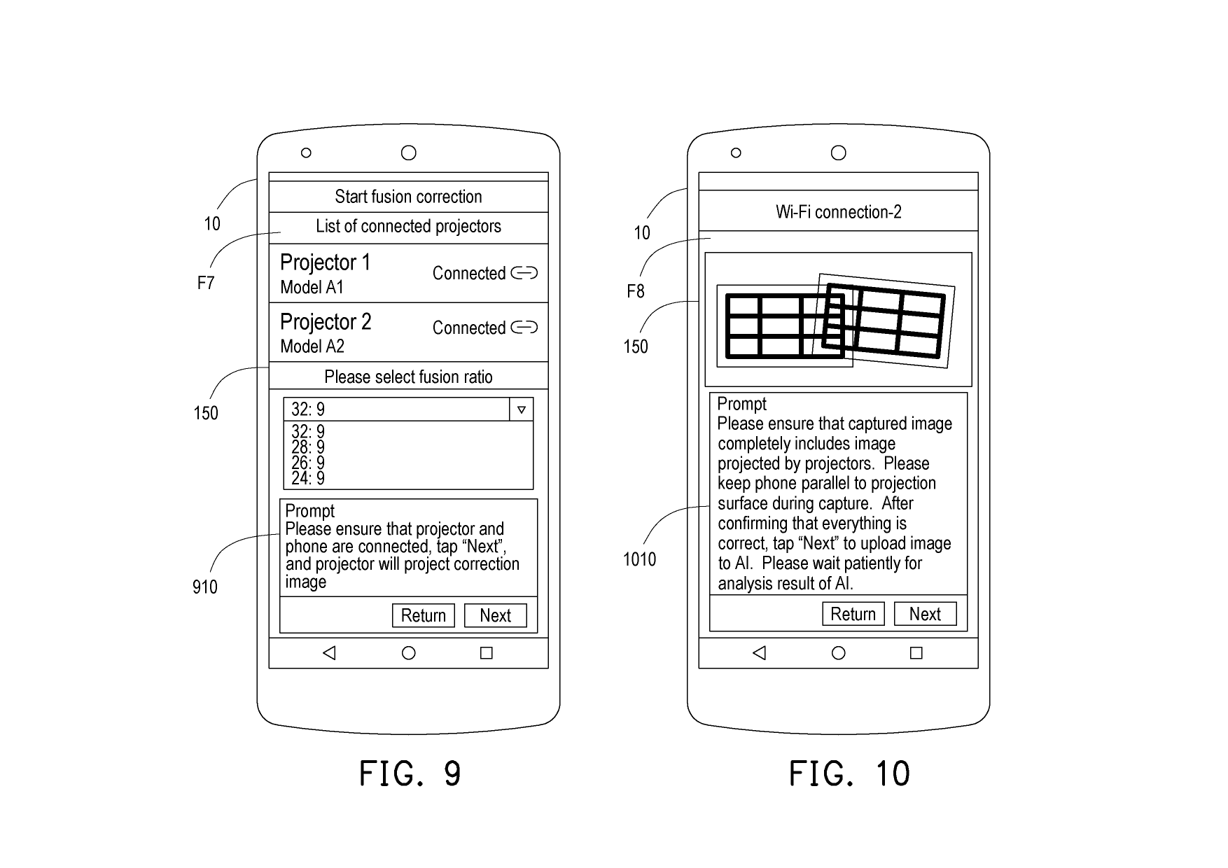

Returning to FIG. 5, after the communicative connection between the electronic device 10 and the multiple projectors 20 is completed, step S513 is executed, in which the fusion ratio is selected. FIG. 9 is a schematic diagram of a guide page for selecting a fusion ratio according to an embodiment of the disclosure. Please refer to FIG. 9. A guide page F7 provides multiple fusion ratios for the user to select, and displays a prompt message 910 to guide the user to tap the “Next” option to enter step S515, in which the projection command is transmitted to each of the projectors 20. It should be noted that although the execution sequence of the APP of the embodiment is to first simultaneously select the arrangement manner and the connection manner in the guide page F2, and then select the fusion ratio in the guide page F7, the disclosure is not limited thereto, and the situation where the sequence of the three steps of “selecting the arrangement manner”, “selecting the connection manner”, and “selecting the fusion ratio” is interchanged is not excluded. In other embodiments, the arrangement manner, the fusion ratio, and the connection manner may also be simultaneously selected in the same guide page. In addition, in the embodiment, the display is adopted as the output device 150 to prompt the arrangement manner, the fusion ratio, and the connection manner. However, in other embodiments, the manner of voice input/output may also be adopted for the user to perform a selection/prompt operation, but not limited thereto.

In step S515, under the premise that the multiple projectors 20 are turned on and successfully communicatively connected to the processor 110 of the electronic device 10, the projection command is transmitted to the communicatively connected projectors 20 according to the prompt (for example, the prompt message 910) in the APP. At this time, each of the projectors 20 receiving the projection command projects image data dedicated to correction to form the correction images on the projection surface 300. The user may also ensure that there is at least one overlapping region between the correction images projected by the multiple projectors 20 by viewing the projection surface 300. If there is no overlapping region, the placement position of the projector 20 may be appropriately adjusted until the overlapping region is generated.

While executing step S515, the APP enables the image capturing device 130, so that the user may capture the correction images on the projection surface through the image capturing device 130. In response to a capturing operation of the user, the captured image is generated in step S517. Next, in step S519, the fusion information including the captured image is uploaded to the artificial intelligence calculation module 30, so that the artificial intelligence calculation module 30 may perform the identification analysis processing on the imaging region of the captured image.

FIG. 10 is a schematic diagram of a guide page for capturing a correction image according to an embodiment of the disclosure. Please refer to FIG. 9 and FIG. 10. After tapping the “Next” option in the guide page F7, the user interface switches to a guide page F8 as shown in FIG. 10. A preview screen of the image capturing device 130 is displayed in the guide page F8, and a prompt message 1010 is displayed to remind the user to ensure the integrity of the captured image. Specifically, the user may ensure that the captured image generated by capturing includes the complete correction image projected by each of the projectors 20 through the preview screen. After image capture is completed and confirmed to be correct, the user may tap “Next” in the guide page F8, so that the APP uploads the fusion information to the artificial intelligence calculation module 30 for the identification analysis processing. In the embodiment, the fusion information includes the captured image, the arrangement manner, and the fusion ratio.

In step S521, the artificial intelligence calculation module 30 determines whether the identification analysis processing is successful. If the identification analysis processing fails, the process returns to step S517, and the APP prompts the user to recapture to generate the captured image. If the identification analysis processing is successful, then in step S523, the artificial intelligence calculation module 30 transmits the adjustment information to the APP. Next, in step S525, the APP generates the adjustment command based on the adjustment information and the projector information. Furthermore, in step S527, the APP transmits the adjustment command to the corresponding projector 20. In step 529, the projector 20 receives the adjustment command and adjusts the projection parameter accordingly.

The artificial intelligence calculation module 30 identifies key information such as the edge and the overlapping region of the correction pattern corresponding to each correction image through the identification analysis processing, and calculates the appropriate fusion strategy and the adjustment information. In an embodiment, the artificial intelligence calculation module 30 is deployed in a cloud server and may be accessed and requested via a specified function variable name or an application program interface (API) through the Internet.

The artificial intelligence calculation module 30 includes an image identification model. The image identification model has basic image identification abilities, that is, the basic abilities of feature extraction and logical computation. Through a large amount of image identification algorithm optimization and prompt word training, the image identification model has the ability to accurately analyze specific pattern images, replacing traditional cumbersome, complex, and professional image identification algorithm tools. A training manner of the image identification model is to provide a large number of fusion images before and after correction to a model database, and inform a fusion correction process, that is, the adjustment parameter and the steps of each of the projectors 20 through prompt word training. Prompt words include, but are not limited to, specific adjustment operations, such as displacement, rotation, scaling, cutting, brightness adjustment, and color balance, of the projector 20. An adjustment algorithm formula, that is, how to convert an image identification result into the correct projector parameter for output must also be present. When the artificial intelligence calculation module 30 receives the uploaded captured image, the image is analyzed according to an identification algorithm summarized in the model database in conjunction with the adjustment algorithm formula outputting the parameter command in the correct format.

The adjustment algorithm formula is a prompt word formula summarized according to an AI training process. The calculation steps and manner of the formula are listed below, under the premise that the captured image captured by the electronic device 10 is not tilted in the vertical and horizontal directions or the influence is so small that the influence may be ignored. In an embodiment, the tilt angle may be obtained through an inertial sensor such as a gyroscope for pre-compensation calculation. Generally speaking, the electronic device 10 and the projection surface are kept as parallel as possible during image capture to achieve a good fusion correction calculation.

In the embodiment, two projectors 20 are used as the minimum processing unit. When the number of the projectors 20 is increased in the horizontal direction, fusion correction is first executed with two projectors 20. After fusion is completed, the fused images are taken as one, and the next one is then fused. The number of the projectors 20 is increased in the vertical direction in the same manner as above. In addition, if the upper and lower projectors need to be aligned in pairs to form an array, the upper two are first processed, the lower two are then processed, and the upper and lower projectors are finally aligned. If apparatuses need to be added, the apparatuses are all processed according to the above principles. After the correction images corresponding to all the projectors 20 are fused, the artificial intelligence calculation module 30 provides the adjustment information required for each of the projectors 20 to the APP, and the APP then converts the adjustment information into the adjustment command accordingly.

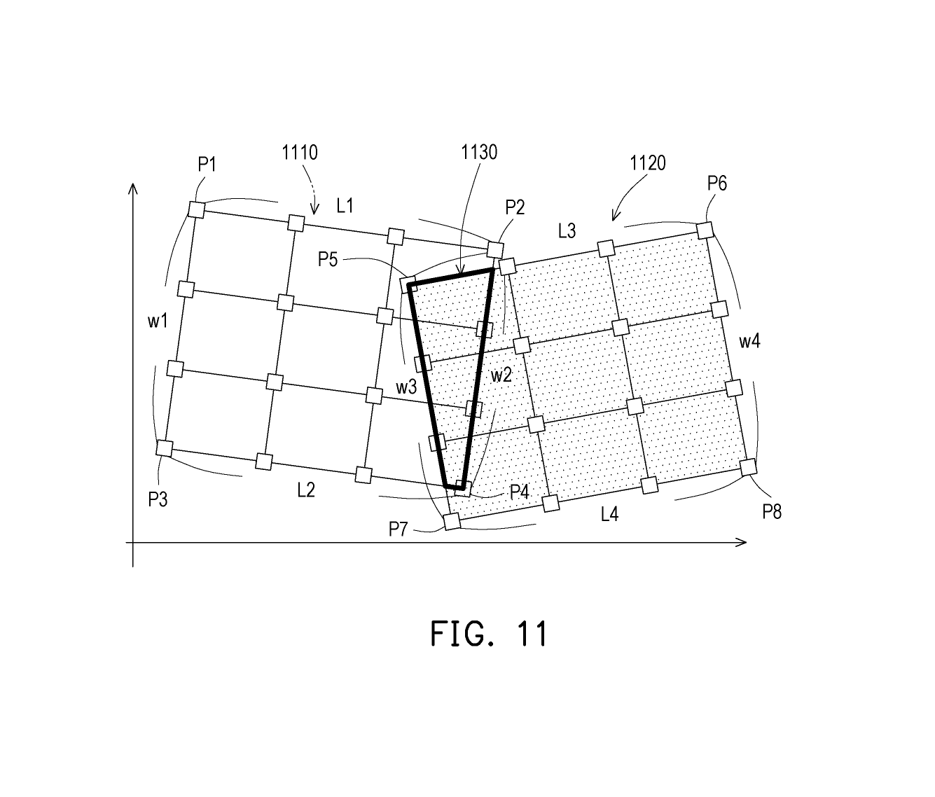

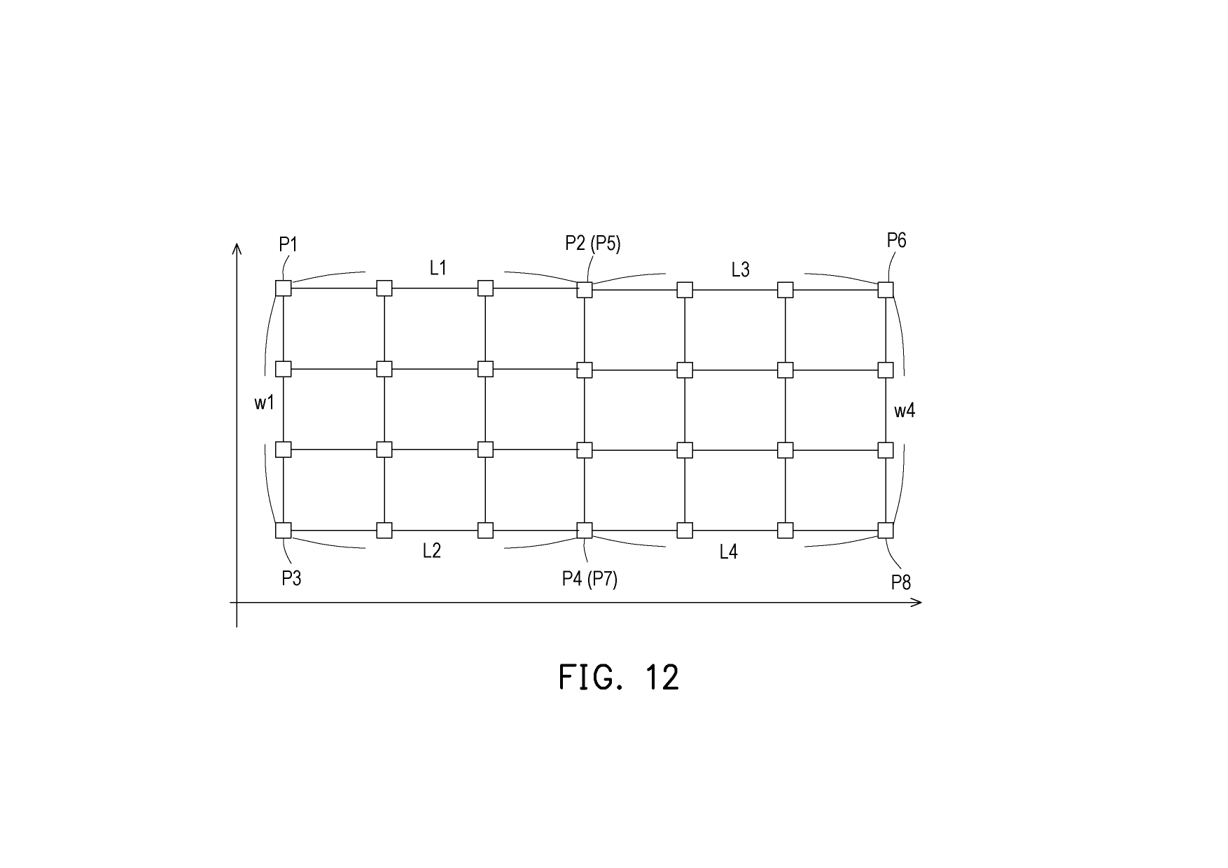

FIG. 11 is a schematic diagram of analyzing a captured image according to an embodiment of the disclosure. FIG. 12 is a schematic diagram of analyzing a fusion image according to an embodiment of the disclosure. For the convenience of description, the embodiment uses image fusion correction performed by adopting the correction images of two projectors 20 as an example for description. The captured image of FIG. 11 forms the fusion image, that is, the fusion image is a desired fused image as shown in FIG. 12 after being adjusted by image fusion correction. Specifically, the coordinate position of each point in the captured image is first calibrated. For a correction pattern 1110 projected by the first projector 20_1, the coordinate position of a vertex P1 of is defined as (x1, y1), the coordinate position of a vertex P2 is defined as (x2, y2), the coordinate position of a vertex P3 is defined as (x3, y3), and the coordinate position of a vertex P4 is defined as (x4, y4). The correction pattern 1110 has an upper length of L1, a lower length of L2, a left width of w1, and a right width of w2. A cosine value of an included angle at an intersection of the Y axis and an extension line of the upper length L1 is COSYL1, and a cosine value of an included angle at an intersection of the Y axis and an extension line of the lower length L2 is COSYL2. For a correction pattern 1120 projected by the second projector 20_2, the coordinate position of a vertex P5 is defined as (x5, y5), the coordinate position of a vertex P6 is defined as (x6, y6), the coordinate position of a vertex P7 is defined as (x7, y7), and the coordinate position of a vertex P8 is defined as (x8, y8). The correction pattern 1120 has an upper length of L3, a lower length of L4, a left width of w3, and a right width of w4. A cosine value of an included angle at an intersection of the Y axis and an extension line of the upper length L3 is COSYL3, and a cosine value of an included angle at an intersection of the Y axis and an extension line of the lower length L4 is COSYL4.

The artificial intelligence calculation module 30 determines the number of projectors participating in fusion calculation, the number of calculations, and establishes a coordinate system according to the arrangement manner and the fusion ratio uploaded by the APP. Therefore, in an embodiment, it is not necessary to upload the information of “how many projectors there are”, and the artificial intelligence calculation module 30 may directly analyze the number of projectors from the captured image.

The artificial intelligence calculation module 30 performs keystone correction on the correction pattern 1110 of the first projector 20_1, so that L1=L2 and w1=w2, and generates a keystone correction value required by the first projector 20_1 after calculation processing. Furthermore, the artificial intelligence calculation module 30 performs rotation correction on the correction pattern 1110, so that COSYL1=COSYL2=0, and generates a rotation value required by the first projector 20_1 after calculation processing. The artificial intelligence calculation module 30 performs keystone correction on the correction pattern 1120 of the second projector 20_2, so that L3=L4 and w3=w4, and generates a keystone correction value required by the second projector 20_2 after calculation processing. Furthermore, the artificial intelligence calculation module 30 executes rotation correction on the correction pattern 1120, so that COSYL3=COSYL4=0, and generates a rotation value required by the second projector 20_2 after calculation processing.

The artificial intelligence calculation module 30 performs alignment processing on the correction pattern 1110 and the correction pattern 1120, as shown in FIG. 12, so that the vertex P2 is aligned with the vertex P5, and the vertex P4 is aligned with the vertex P7, that is, x5=x2=x1+L1, y5=y2, x7=x4=x3+L2, and y7=y4=y2+w2.

In addition, determination and processing are performed on an overlapping region 1130. For example, if the x-coordinate value of the vertex P5 or the vertex P7 is less than the x-coordinate value of the vertex P2 or the vertex P4, it is determined that the correction pattern 1110 and the correction pattern 1120 have the overlapping region 1130. At this time, darkening processing (that is, adjusting brightness to 0) is performed on a left projection region of the correction pattern 1120, and a local darkening processing value and command are generated after calculation processing.

The artificial intelligence calculation module 30 further executes brightness balance processing on the correction pattern 1110 and the correction pattern 1120, calculates a brightness grayscale difference value, and provides a calculated average brightness value. Since white light projected by the projector 20 is composed of RGB three-color light, the artificial intelligence calculation module 30 may also execute color balance processing on the correction pattern 1110 and the correction pattern 1120, compare white color temperature values of the correction pattern 1110 and the correction pattern 1120, and provide a calculated average RGB three-color temperature value. In addition, if coordinates of some points are inconsistent on the X and Y axes due to unevenness of the projection surface, the artificial intelligence calculation module 30 will calculate an adjustment value of a deviation value required for each point.

In an embodiment, the adjustment information calculated by the artificial intelligence calculation module 30 is packaged in the JavaScript Object Notation (JSON) format. The adjustment information is transmitted to the APP through the HyperText Transfer Protocol (HTTP), then converted into the adjustment command corresponding to each of the projectors 20 by the APP, and then transmitted to each of the projectors 20 for execution.

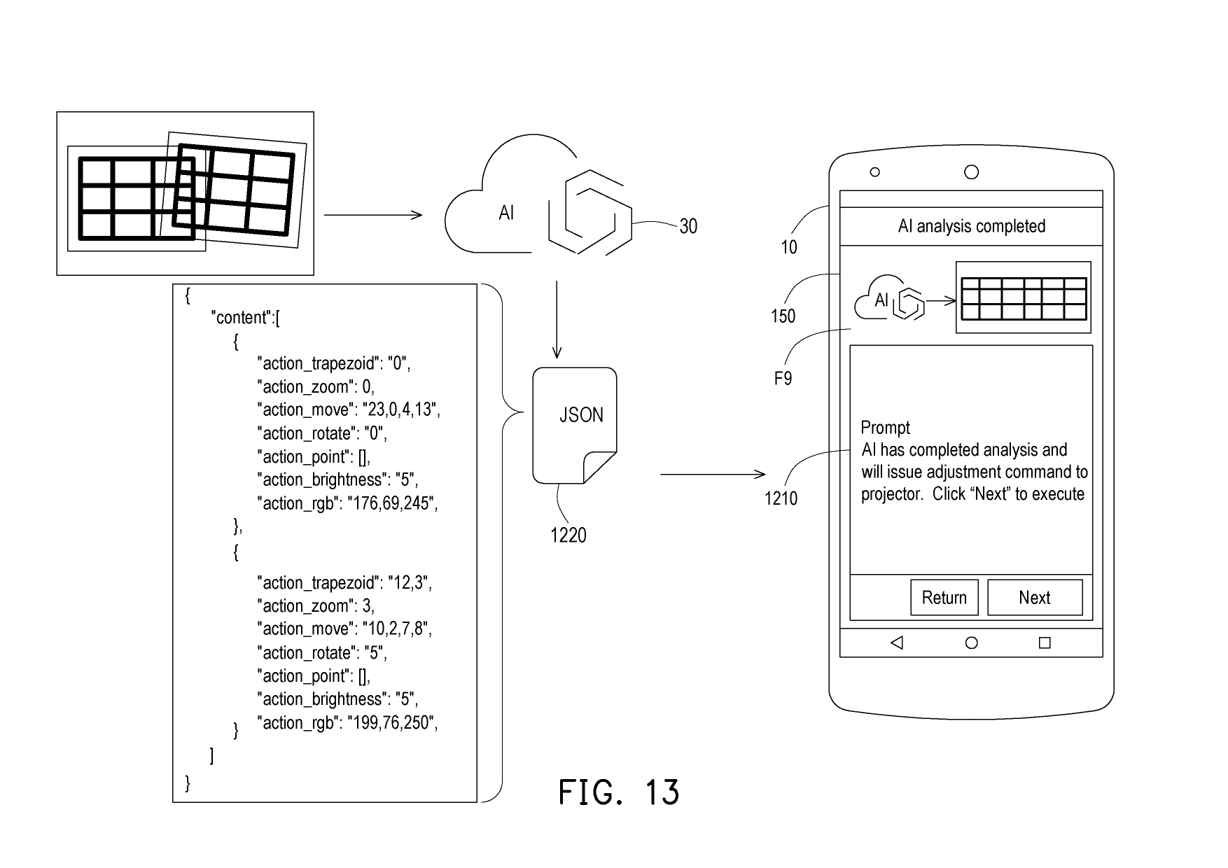

FIG. 13 is a schematic diagram of AI computation and sending an analysis result to an electronic device according to an embodiment of the disclosure. Please refer to FIG. 13. The APP transmits the fusion information including the captured image, the arrangement manner, and the fusion ratio to the artificial intelligence calculation module 30 for identification analysis processing through an HTTP POST request. After analyzing the imaging region of the captured image, the artificial intelligence calculation module 30 automatically generates the adjustment parameter corresponding to each of the projectors 20 at one time according to the adjustment algorithm formula, and packages the adjustment parameters in the JSON format to generate a JSON file 1220. Afterwards, the JSON file 1220 is transmitted to the electronic device 10. After receiving the JSON file 1220, the user interface of the electronic device 10 switches to a guide page F9. A prompt message 1210 is displayed in the guide page F9 to inform the user to tap the “Next” option in the guide page F9 to adjust the multiple projectors 20. After receiving the adjustment information (for example, the JSON file 1220), the electronic device 10 sends the adjustment commands for controlling the multiple projectors 20 to perform displacement, rotation, scaling, cutting, brightness adjustment, and/or color adjustment, etc. through the Wi-Fi module or the Bluetooth module, etc., so as to implement seamless fusion projection.

Specifically, the multiple projectors 20 performing fusion correction are not necessarily of the same model, and the multiple projectors 20 of different models may have different command sets. Therefore, during the process of converting the adjustment information into the adjustment command, the APP matches and converts the adjustment command to the corresponding projector 20 according to the model obtained and the command set used when the APP is connected and paired.

After receiving the JSON file 1220, the APP parses the JSON file 1220 and converts the adjustment information into the adjustment command corresponding to at least one of the multiple projectors 20. If the adjustment information provided by the artificial intelligence calculation module 30 differs from a threshold specified by the command set corresponding to the projector model, the APP will calculate and obtain a new adjustment command according to the threshold, and gradually send the new adjustment command to the corresponding projector 20 through the Wi-Fi module or the Bluetooth module.

Returning to FIG. 5, after the new adjustment command is gradually sent to the corresponding projector 20 through the Wi-Fi module or the Bluetooth module and the projection parameter is adjusted (step S529), the process may further enter step S531, in which it is determined whether the execution is successful. At this time, it is determined whether all the projectors 20 adjusted the projection parameters according to the adjustment commands. If there is any projector 20 that did not adjust the projection parameter, it is determined that the execution is not successful, and the process returns to step S527 to resend the adjustment command or the process returns to step S501 to reactivate the correction function of the APP. If all the projectors 20 adjusted the projection parameters according to the adjustment commands, it is determined that the execution is successful, and step S533 is further executed, in which whether the user is satisfied with an adjusted projection result is queried by the user interface of the APP. At this time, the user may determine whether the correction images still have the overlapping region or whether the correction images after adjustment are similar to the fusion image of FIG. 12 through viewing the projection surface, so as to evaluate whether a result of fusion correction is satisfactory. If satisfactory, in step S535, adjusted parameter information is saved. If not satisfactory, the process may return to step S513 to reselect the fusion ratio and execute steps S515 to S533. Alternatively, if not satisfactory, parameter settings of the projector may also be manually corrected in step S537.

In addition, if the communicative connection between the electronic device 10 and any of the projectors 20 is disconnected during the process of fusion correction, the APP will prompt the user to check the network or Bluetooth connection status, and the process returns to step S501 shown in FIG. 5 to reactivate the correction function of the APP and continue the communicative connection between the electronic device 10 and the multiple projectors 20. After the communicative connection between the electronic device 10 and the multiple projectors 20 is restored, fusion correction may continue to be executed according to the previously stopped step or the current operation may be terminated, and the correction images formed on the projection surface may be recaptured to generate the captured image.

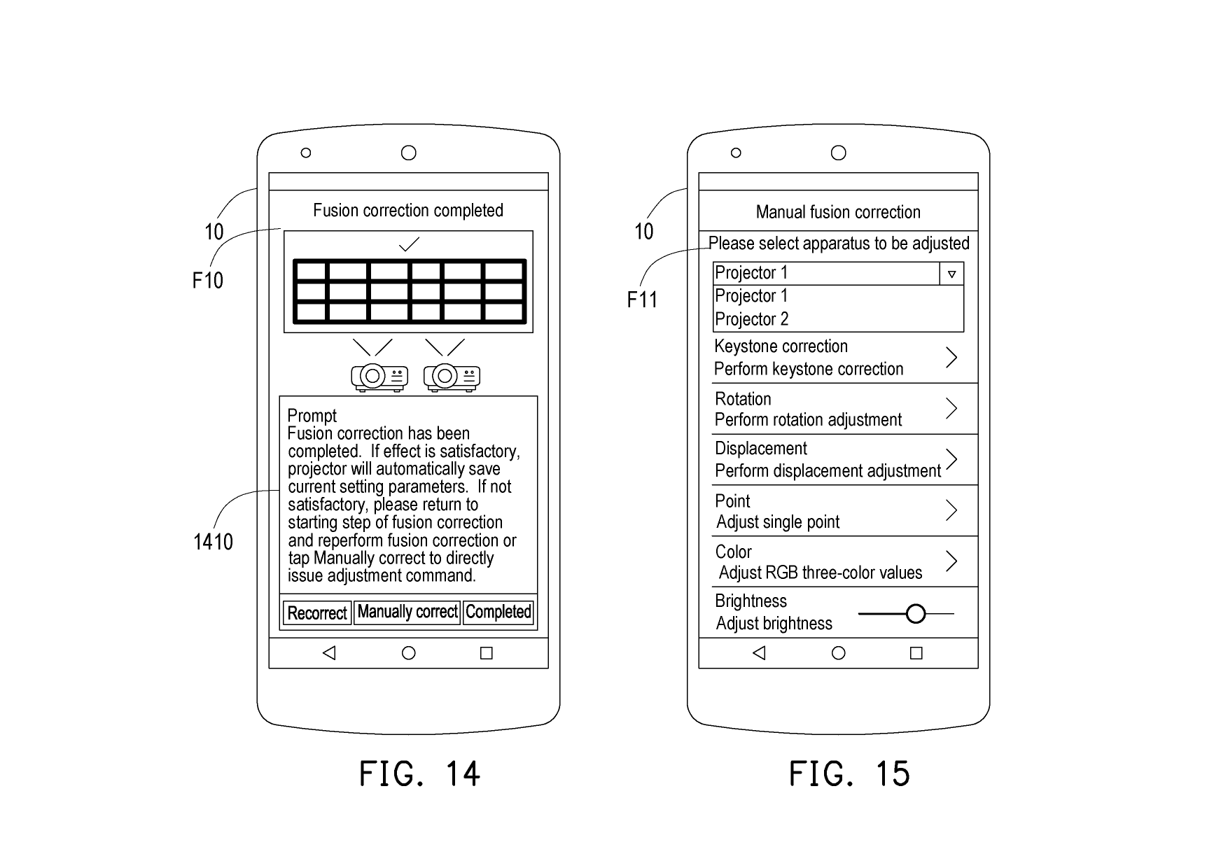

FIG. 14 is a schematic diagram of a guide page after fusion correction is completed according to an embodiment of the disclosure. In the embodiment, after tapping the “Next” option in the guide page F9 as shown in FIG. 13 to adjust the projector 20, if the APP determines that the execution is successful in step S531, the user interface switches to a guide page F10 as shown in FIG. 14. The guide page F10 includes a prompt message 1410 to prompt the user that fusion correction is completed.

If the user is not satisfied with a result after fusion correction, the user may tap the “Recorrect” option to return to step S513. At this time, the user interface of the APP switches to the guide page F7 as shown in FIG. 9 to reselect the fusion ratio, and continue with the subsequent steps. In addition, the user may also tap the “Manual correction” option to directly perform manual adjustment on the user interface of the APP. FIG. 15 is a schematic diagram of a guide page for manual fusion correction according to an embodiment of the disclosure. In the embodiment, after tapping the “Manually correct” option in the guide page F10 as shown in FIG. 14, the user interface switches to a guide page F11 as shown in FIG. 15. The guide page F11 includes adjustment options for various parameter values to provide the user with operations for adjusting the projector 20. In this way, the “Recorrect” and/or “Manually correct” steps may be repeated until the effect is satisfactory.

According to the above, after fusion correction is completed, the APP may prompt that fusion correction is completed, and the user may check the correction effect and make fine adjustments (if necessary). After the effect is satisfactory, the APP saves the current setting parameter values of all the projectors 20, so that when the projectors 20 are subsequently enabled for projection, projection may be performed according to the saved adjustment information.

In summary, the disclosure provides the method for projection image fusion correction and the system for projection image fusion correction of multiple projectors based on artificial intelligence analysis and the non-transitory computer readable storage medium. The disclosure abandons the traditional correction manner that relies on professional software, and instead uses the image capturing device of the electronic device to capture the correction images projected by the projectors, performs image analysis through artificial intelligence, and automatically calculates and outputs the adjustment information of each projector to implement seamless fusion projection. Accordingly, correction complexity is reduced, correction efficiency is improved, and various projection scenarios are adaptable.

The disclosure uses artificial intelligence image identification technology. In terms of hardware apparatus compatibility, it is only necessary to supplement the parameters of the communication and executing the adjustment operations of different projectors. The artificial intelligence calculation module can automatically identify issues such as misalignment, color difference, and uneven brightness in the images based on the deep learning algorithm, and calculate the appropriate fusion strategy. Through continuous training of the artificial intelligence calculation module, the model database may be continuously upgraded and expanded to cope with more and more complex scenarios, and identification efficiency and the fusion effect may also be further improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for projection image fusion correction, adapted to a system for projection image fusion correction, wherein the system for projection image fusion correction comprises: a plurality of projectors, an artificial intelligence calculation module, and an electronic device, wherein the electronic device comprises: a communication connector, an image capturing device, and a processor, wherein the processor is coupled to the communication connector and the image capturing device, and the processor is configured to execute the method, the method comprising following steps of:
communicatively connecting to each of the plurality of projectors through the communication connector;
controlling each of the plurality of projectors to project to form a plurality of correction images on a projection surface, wherein the plurality of correction images have at least one overlapping region on the projection surface;
enabling the image capturing device, so that the image capturing device generates a captured image in response to image capture, wherein the captured image comprises an imaging region corresponding to the plurality of correction images;
obtaining the captured image from the image capturing device, and transmitting fusion information comprising the captured image to the artificial intelligence calculation module, wherein the artificial intelligence calculation module performs identification analysis processing on the imaging region of the captured image to generate at least one adjustment information, wherein the at least one adjustment information corresponds to at least one projector among the plurality of projectors;
generating at least one adjustment command according to the at least one adjustment information and a plurality of projector information of the plurality of projectors, wherein the plurality of projector information respectively correspond to the plurality of projectors, and the at least one adjustment command corresponds to the at least one projector among the plurality of projectors; and
transmitting the at least one adjustment command to the corresponding at least one projector among the plurality of projectors by the communication connector, wherein the at least one projector among the plurality of projectors adjusts a projection parameter based on the at least one adjustment command correspondingly received.

2. The method for projection image fusion correction according to claim 1, wherein the fusion information further comprises arrangement information of the plurality of projectors, and in response to communicative connection between the electronic device and each of the plurality of projectors, the method further comprises following steps of:
prompting a plurality of arrangement manners of the plurality of projectors by the electronic device; and
generating the arrangement information by the electronic device in response to selecting one of the plurality of arrangement manners.

3. The method for projection image fusion correction according to claim 1, wherein the fusion information further comprises fusion ratio information of the plurality of projectors, and in response to communicative connection between the electronic device and each of the plurality of projectors, the method further comprises following steps of:
prompting a plurality of fusion ratios of the plurality of projectors by the electronic device; and
generating the fusion ratio information by the electronic device in response to selecting one of the plurality of fusion ratios.

4. The method for projection image fusion correction according to claim 1, wherein in response to communicative connection between the electronic device and each of the plurality of projectors, the method further comprises:
obtaining the corresponding projector information from each of the plurality of projectors by the electronic device.

5. The method for projection image fusion correction according to claim 1, wherein each of the plurality of projector information comprises a model of the corresponding projector and a command set used.

6. The method for projection image fusion correction according to claim 1, wherein the step of enabling the image capturing device of the electronic device, so that the image capturing device generates the captured image in response to image capture further comprises following steps of:
detecting a posture of the electronic device relative to a direction of gravity during image capture through an inertial sensor of the electronic device to obtain posture information; and
performing compensation correction on the captured image according to the posture information by the electronic device, and transmitting the captured image after compensation correction to the artificial intelligence calculation module as a part of the fusion information.

7. The method for projection image fusion correction according to claim 1, wherein the plurality of projectors adopt a same resolution for projection.

8. The method for projection image fusion correction according to claim 1, wherein each of the plurality of correction images formed on the projection surface has a correction pattern, and there is a spacing between a pattern boundary of the correction pattern and a projection boundary of the corresponding correction image.

9. The method for projection image fusion correction according to claim 1, wherein the at least one adjustment information generated by the artificial intelligence calculation module after the identification analysis processing is a plurality of adjustment information, and the plurality of adjustment information respectively correspond to the plurality of projectors; the at least one adjustment command generated by the electronic device according to the plurality of adjustment information and the plurality of projector information is a plurality of adjustment commands, wherein the plurality of adjustment commands respectively correspond to the plurality of projectors, wherein after the electronic device generates the plurality of adjustment commands according to the plurality of adjustment information and the plurality of projector information, the method further comprises a following step of:
determining whether each of the plurality of adjustment commands exceeds a threshold of the corresponding projector, and regenerating the plurality of adjustment commands according to the threshold until each of the plurality of adjustment commands does not exceed the corresponding threshold in a case where any of the plurality of adjustment commands exceeds the corresponding threshold.

10. A system for projection image fusion correction, comprising: a plurality of projectors, an artificial intelligence calculation module, and an electronic device, wherein the electronic device comprises: a communication connector, an image capturing device, and a processor, wherein:
the communication connector is configured to be communicatively connected to each of the plurality of projectors; and
the processor is coupled to the communication connector and the image capturing device and is configured to execute:
controlling each of the plurality of projectors to project to form a plurality of correction images on a projection surface, wherein the plurality of correction images have at least one overlapping region on the projection surface;
enabling the image capturing device, so that the image capturing device performs image capture to generate a captured image;
obtaining the captured image from the image capturing device, wherein the captured image comprises an imaging region corresponding to the plurality of correction images;
transmitting fusion information comprising the captured image to the artificial intelligence calculation module, wherein the artificial intelligence calculation module performs identification analysis processing on the imaging region of the captured image to generate at least one adjustment information, wherein the at least one adjustment information corresponds to at least one projector among the plurality of projectors;
generating at least one adjustment command according to the at least one adjustment information and a plurality of projector information of the plurality of projectors, wherein the plurality of projector information respectively correspond to the plurality of projectors, and the at least one adjustment command corresponds to the at least one projector among the plurality of projectors; and
respectively transmitting the at least one adjustment command to the corresponding at least one projector among the plurality of projectors, wherein the at least one projector among the plurality of projectors adjusts a projection parameter based on the at least one adjustment command correspondingly received.

11. The system for projection image fusion correction according to claim 10, wherein the processor is configured to execute: communicatively connecting the electronic device to each of the plurality of projectors through the communication connector according to a fusion correction command.

12. The system for projection image fusion correction according to claim 10, wherein the fusion information further comprises: arrangement information of the plurality of projectors, and the processor is configured to execute:
prompting a plurality of arrangement manners of the plurality of projectors through an output device; and
generating the arrangement information in response to selecting one of the plurality of arrangement manners.

13. The system for projection image fusion correction according to claim 10, wherein the fusion information further comprises fusion ratio information of the plurality of projectors, and the processor is configured to execute:
prompting a plurality of fusion ratios of the plurality of projectors through an output device; and
generating the fusion ratio information in response to selecting one of the plurality of fusion ratios.

14. The system for projection image fusion correction according to claim 10, wherein the processor is configured to execute:
obtaining the corresponding projector information from each of the plurality of projectors.

15. The system for projection image fusion correction according to claim 10, wherein each of the plurality of projector information comprises a model of the corresponding projector and a command set used.

16. The system for projection image fusion correction according to claim 10, wherein the electronic device further comprises an inertial sensor, wherein the inertial sensor is configured to detect a posture of the electronic device relative to a direction of gravity during image capture, and generate posture information, and the processor is configured to execute:
obtaining the posture information through the inertial sensor;
performing compensation correction on the captured image according to the posture information, and transmitting the captured image after compensation correction to the artificial intelligence calculation module as a part of the fusion information.

17. The system for projection image fusion correction according to claim 10, wherein the processor is configured to execute: controlling the plurality of projectors to adopt a same resolution for projection.

18. The system for projection image fusion correction according to claim 10, wherein each of the plurality of correction images formed on the projection surface has a correction pattern, and there is a spacing between a pattern boundary of the correction pattern and a projection boundary of the corresponding correction image.

19. The system for projection image fusion correction according to claim 10, wherein the processor is configured to execute:
determining whether each of the plurality of adjustment commands exceeds a threshold of the corresponding projector, and regenerating the plurality of adjustment commands according to the threshold until each of the plurality of adjustment commands does not exceed the corresponding threshold in a case where any of the plurality of adjustment commands exceeds the corresponding threshold.

20. A non-transitory computer readable storage medium, storing an application program executable by a processor, wherein the application program is configured to complete the method for projection image fusion correction according to claim 1 when executed by the processor.
